(19) United States
(12) Patent Application Publication
(10) Pub. No.: US 2005/0171831 A1
(43) Pub. Date: Aug. 4, 2005

(54) Testing practices assessment toolkit

(76) Inventors: Gary G. Johnson, Ottawa (CA); Susan B. Herrick, Marlborough, MA (US); Carol A. Cruise, Ottawa (CA)

Correspondence Address: STEPHEN R. LOE, THE LAW OFFICE OF STEPHEN R. LOE, P.O. BOX 649, FRISCOE, TX, 75034, US

(21) Appl. No.: 10/769,503

(22) Filed: Jan. 31, 2004

(51) Int. Cl. G06F 17/60

(52) U.S. Cl. 705/10

(57) ABSTRACT

A method, system, and computer program product for analyzing project testing practices of an organization is provided. In one embodiment, a consultant is provided with a set of documents utilized for initiating the testing practices assessment process as well as with a testing assessment questionnaire. The questions in the questionnaire are tailored to a select number of key focal areas and provide the consultant with a standardized set of questions leading to repeatability of the process and quantization of results and recommendations. The consultant is also provided with a spreadsheet for entering the consultant's observations and the organization's answers to the questionnaire. A graphical representation of maturity levels for a select number of sub-levels for at least one of the key focal areas is generated based on the consultant's entries in the spreadsheet.

### CROSS REFERENCE TO RELATED APPLICATIONS

The present application is related to co-pending U.S. patent application Ser. No. ______ (Client Docket No. LEDS.00133) entitled “TESTING PRACTICES ASSESSMENT PROCESS” filed even date herewith. The content of the above mentioned commonly assigned, co-pending U.S. Patent application is hereby incorporated herein by reference for all purposes.

### BACKGROUND OF THE INVENTION

1. Technical Field

The present invention relates generally to computer software and, more particularly, to assessing testing practices used in optimizing software development.

2. Description of Related Art

Secure testing of software and project development can account for up to 40% to 50% of a project's total cost, time and resources. Furthermore, testing can mitigate project risks, ensure successful implementations and promote customer satisfaction. However, for many organizations, testing is not seen as a priority activity, with the majority of project funds spent on development and production support. Thus, many organizations, failing to realize the importance of testing, utilize poorly designed or ad hoc testing practices in measuring the maturity and quality of the software under development. Therefore, the organization lacks sufficient information to determine which areas to concentrate resources on in improving the software. Thus, unnecessary time and expense are expended in developing software due to poor testing practices which also leads to poor quality. Furthermore, many organizations may have a goal of achieving a certain project maturity level, but are unable to do so because of poor testing practices.

Therefore, it is desirable to have a testing assessment method and system that allows an organization to determine weaknesses in its testing practices and software under development in order to focus resources in the proper area. Furthermore, it is desirable to have a visual representation that would effectively highlight the areas requiring improvement as well as providing the organization with a list of recommendations that would allow them to demonstrate improvement at a follow-up assessment.

### SUMMARY OF THE INVENTION

The present invention provides a method, system, and computer program product for analyzing project testing practices of an organization. In one embodiment, a consultant is provided with a set of documents utilized for initiating the testing practices assessment process as well as with a testing assessment questionnaire. The questions in the questionnaire are tailored to a select number of key focal areas and provide the consultant with a standardized set of questions leading to repeatability of the process and quantization of results and recommendations. The consultant is also provided with a spreadsheet for entering the consultant's observations and the organization's answers to the questionnaire. A graphical representation of maturity levels for a select number of sub-levels for at least one of the key focal areas is generated based on the consultant's entries in the spreadsheet.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which one embodiment of a testing assessment tool kit for assessing the project testing practices of an organization according to the present invention may be implemented;

FIG. 2 depicts a block diagram of a data processing system in which the present invention may be implemented;

FIG. 3 depicts a flow chart illustrating an exemplary process for analyzing an organizations testing practices as well as toolkit components to aid in that process in accordance with one embodiment of the present invention; and

FIG. 4 depicts an example of a Graphical Testing Assessment Report in accordance with one embodiment of the present invention.

### DETAILED DESCRIPTION OF THE PREFERRED EMBODIMENT

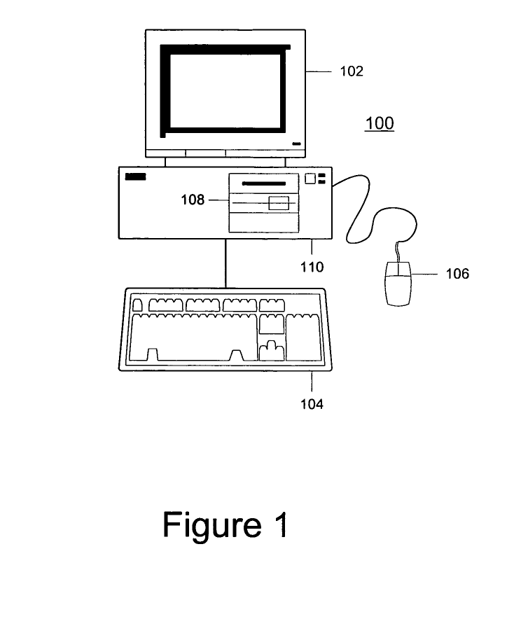

With reference now to the figures, and in particular with reference to FIG. 1, a pictorial representation of a data processing system is depicted in which one embodiment of a testing assessment tool kit for assessing the project testing practices of an organization according to the present invention may be implemented. The Testing Practices Assessment Toolkit allows a consultant to analyze, using a process of the present invention, the testing procedures of a client organization to determine whether proper testing practices are being utilized to ensure the success of the organizations project. The Testing Practices Assessment Toolkit provides a consultant with tools that ensure when a subsequent assessment is performed, only the results may change—not the process. This toolkit:
Provides the questions for client interviews;
Provides a means of recording client answers and mapping them to the maturity levels;
Identifies best practices;
Provides checklists to analyse project testing documentation;
Provides a guideline for improvements over the short and long term;
Provides an objective, unbiased review of testing practices;
Provides consistency regardless of the consultant performing the assessment;
Provides consistency between the initial assessment and follow-up assessments.

A personal computer 100 is depicted which includes a system unit 110, a video display terminal 102, a keyboard 104, storage devices 105, which may include floppy drives and other types of permanent and removable storage media, and a pointing device 106, such as a mouse. Additional input devices may be included with personal computer 100, as will be readily apparent to those of ordinary skill in the art.

The personal computer 100 can be implemented using any suitable computer. Although the depicted representation shows a personal computer, other embodiments of the present invention may be implemented in other types of data processing systems, such as mainframes, workstations, network computers, Internet appliances, palm computers, etc.

The system unit 110 comprises memory, a central processing unit, one or more I/O units, and the like. However, in the present invention, the system unit 110 preferably contains a speculative processor, either as the central processing unit (CPU) or as one of multiple CPUs present in the system unit.

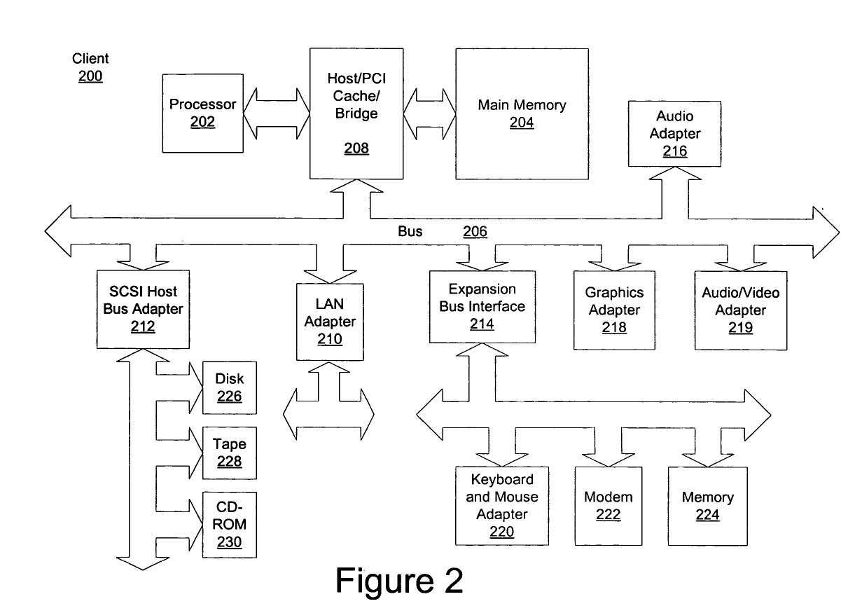

With reference now to FIG. 2, a block diagram of a data processing system in which the present invention may be implemented is illustrated. Data processing system 200 is an example of a computer such as that depicted in FIG. 1. A Testing Practices Assessment Tool Kit according to the present invention may be implemented on data processing system 200. Data processing system 200 employs a peripheral component interconnect (PCI) local bus architecture. Although the depicted example employs a PCI bus, other bus architectures, such as Micro Channel and ISA, may be used. Processor 202 and main memory 204 are connected to PCI local bus 206 through PCI bridge 208. PCI bridge 208 may also include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter (A/V) 219 are connected to PCI local bus 206 by add-in boards inserted into expansion slots. Expansion bus interface 214 provides a connection for a keyboard and mouse adapter 220, modem 222, and additional memory 224. In the depicted example, SCSI host bus adapter 212 provides a connection for hard disk drive 226, tape drive 228, CD-ROM drive 230, and digital video disc read only memory drive (DVD-ROM) 232. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 200. Instructions for the operating system, the object-oriented operating system, and applications or programs are located on a storage device, such as hard disk drive 226, and may be loaded into main memory 204 for execution by processor 202.

Those of ordinary skill in the art will appreciate that the hardware in FIG. 2 may vary depending on the implementation. For example, other peripheral devices, such as optical disk drives and the like, may be used in addition to or in place of the hardware depicted in FIG. 2. The depicted example is not meant to imply architectural limitations with respect to the present invention. For example, the processes of the present invention may be applied to multiprocessor data processing systems.

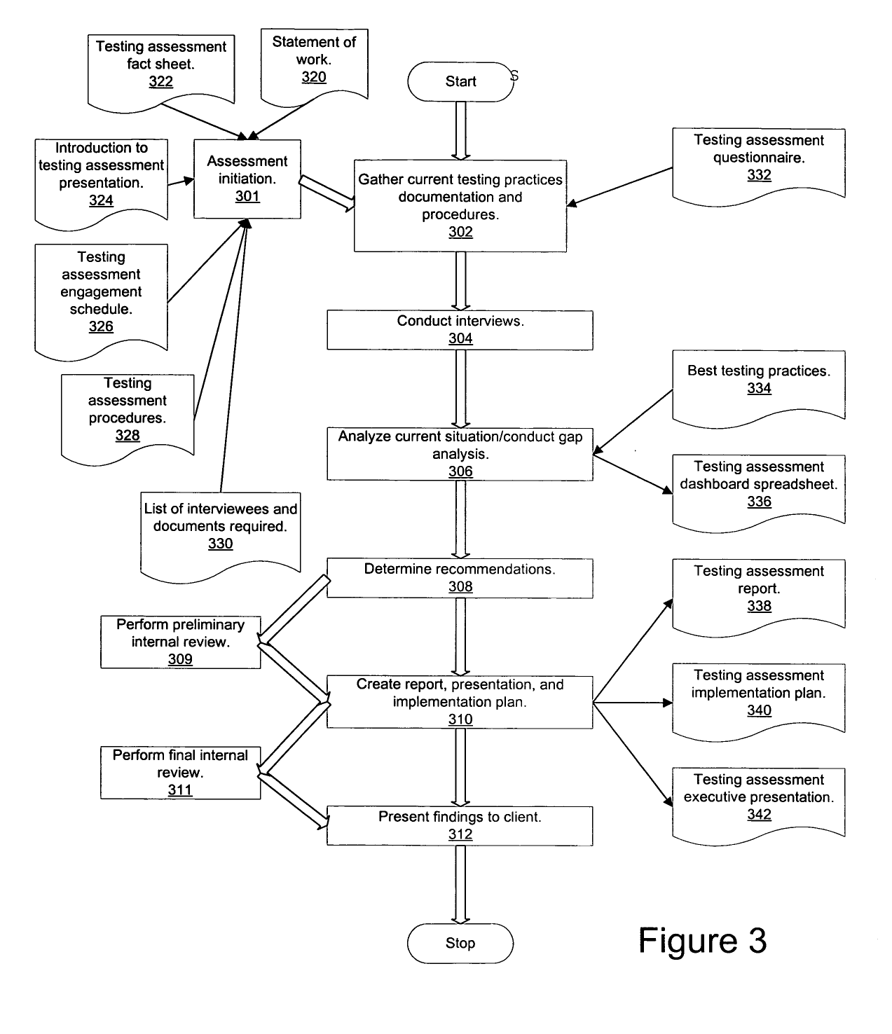

With reference now to FIG. 3, a flow chart illustrating an exemplary process for analyzing an organizations testing practices as well as toolkit components to aid in that process is depicted in accordance with one embodiment of the present invention. This procedure for performing Testing Practices Assessments provides a consultant with a repeatable process that:
Identifies the strengths of the existing testing practices;
Identifies current and potential problems;
Identifies beneficial and achievable improvements;
Provides a guideline for achieving improvements over the short and long term.

Testing consultants gather information on the current testing process through a structured questionnaire, interviews and review of project documentation. This information is analyzed, improvement opportunities are identified, and recommended solutions are presented to the client. This analysis is accomplished through a consultant's:
Understanding and evaluating the client's testing practices;
Understanding and evaluating the conformity of the testing team to best practices;
Assessing the quality of the work being produced;
Measuring the progress of the testing team against the schedule;
Mapping this information to best practices (gap analysis).

Questionnaires and interviews are used to gather information. Questions are divided into key categories: Testing Organization, Testing Strategy, Test Planning, Testing Management, and Testing Environment and Tools. The assessment compares industry best practices against the current testing situation. The resulting gap analysis provides the basis for the recommendations. A final report provides a client with the assessment findings as well as strategic, tactical recommendations.

Throughout this process the consultant management and Subject Matter Experts review and approve deliverables to ensure consistency, correctness, and fit to the original statement of work.

The diagram illustrated in FIG. 3 identifies the activities involved in the testing process assessment. To begin, a consultant gathers current testing practices documentation and procedures (step 302). This documentation and procedures includes toolkit documents 320-328 that are part of an assessment initiation 301 as well as a testing assessment questionnaire 332. These documents that are part of the toolkit as well as other parts of the toolkit will be discussed in greater detail below.

Once the consultant has gathered together the appropriate documentation and procedures, the consultant conducts interviews with members of the client organization (step 304). Next, the consultant analyzes the current situation and conducts gap analysis comparing the organizations practices against an industry standard best testing practices 334 and supplying answers to a testing assessment dashboard spreadsheet 336 (step 306). The testing assessment dashboard spreadsheet 336 will be discussed in greater detail below.

The consultant then determines recommendations (step 308) based on the consultants experience in combination with the assessment process and toolkit of the present invention. A preliminary internal review may be performed if desired (step 309) and then the consultant creates a report 338, presentation 340, and implementation plan 342 (step 310). The report 338, plan 340, and presentation 342 are created using the toolkit thus ensuring a consistent format. Next, a final internal review may be performed (step 311) and then the findings are presented to the client (step 312).

The toolkit inputs consist of a Testing Assessment Statement of Work 320, a Testing Assessment Fact Sheet 322, an Introduction to Testing Assessment Presentation 324, a Testing assessment Engagement Schedule 326, Testing Assessment Procedures 328, a List of Interviewees and Documents Required 330, a Testing Assessment Questionnaire 332, Best Testing Practices 334, and E-mail messages to be sent to client (which is not shown in FIG. 3). The e-mail message to be sent to the client contains basic information about the testing assessment. The initial message may contain the Testing Assessment Fact Sheet 322 and the introductory Presentation 324. The toolkit outputs consist of a Testing Assessment Dashboard Spreadsheet 336, a Testing Assessment Report 338, a Testing Practices Assessment Improvement Plan 340, and a Testing Assessment Executive Presentation 342. The toolkit outputs may also include a Gap Analysis Observations Review Meeting Minutes template, a Recommended Approach Review Meeting Minutes template, a Proposed Testing Practices Improvement Plan Review Meeting Minutes template, and a Presentation of Assessment Improvement Plan to Client Meeting Minutes template.

The testing assessment statement of work document 320 is a document that serves as a contractual summary of all work necessary to implement a testing assessment and to provide the required products and services. The testing assessment fact sheet 322 is a document identifying what a testing assessment is, who performs one, and what outputs are produced. The Introduction to Testing Assessment Presentation 324 is a presentation, in a format such as, for example, Microsoft PowerPoint®, that contains an introduction to the Testing Assessment, indicating why an assessment could or should be performed and what benefits can result from the assessment. The Testing Assessment Engagement Schedule 326 is a schedule consisting of project task names, task dependencies, and task duration that together determine the start date and the end date of the project. The Testing Assessment Procedures 328 is a document identifying the inputs, procedure, and outputs used in a testing assessment. The List of Interviewees and Documents Required 330 is a document containing a list of team members that should receive the Testing Assessment Questionnaire and/or be interviewed by the consultant. This document also identifies the project documents that should be reviewed. The Testing Assessment Questionnaire 332 is a document containing detailed questions regarding Testing Organization, Testing Strategy, Test Planning, Testing Management, and Testing Environment and Tools. The Best Testing Practices Documents 334 are documents containing detailed best testing practices by stage as defined by the consultant's enterprise testing community and other industry measures.

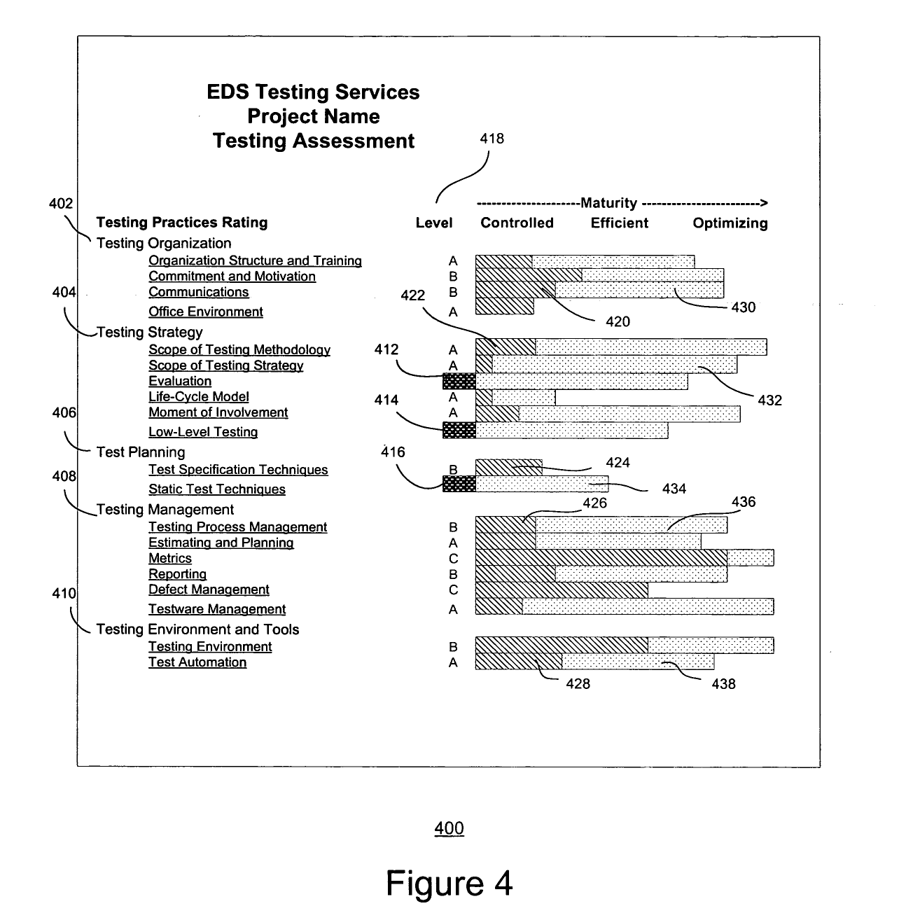

The Testing Assessment Dashboard Spreadsheet 336 is a spreadsheet where all the answers from the questionnaire are recorded. This spreadsheet contains formulas that analyze the answers and generate a “dashboard” view of the current state of the testing practices. The formulas utilized are dependent upon the particular industry or project being analyzed since the best practices for a particular industry may vary from that of other industries. The Testing Assessment Report 338 is a document used to record the observations, concerns, and recommendations that, if implemented, would, in the opinion of the consultant, improve the testing practices of the client organization. The questions are grouped into five main areas: Testing Organization, Testing Strategy, Test Planning, Testing Management, and Testing Environment and Tools. Each main area has a list of questions that should be answered and the results of those answers used to construct a graphical report such as that depicted in FIG. 4. The graphical report is part of the Testing Assessment Report 338 and can be presented to the client to provide a simple method of communicating the results of the Testing Practices Assessment. An example of a Testing Assessment Dashboard Spreadsheet 336 containing a Testing Assessment Questionnaire questions is depicted in Appendix A, the contents of which are hereby incorporated herein for all purposes.

The Testing Assessment Improvement Plan 340 is a document used to record a recommended improvement plan based on the recommendations in the Testing Assessment Report document 338. The Testing Assessment Executive Presentation 342 is a high-level executive summary presentation template, implemented, for example, as a Microsoft PowerPoint® template, that borrows designate key points from the Testing Assessment Report document 338 that focus on business benefits (e.g., improvements in efficiency that reduce time and/or cost and improvements in effectiveness that produce a quality product).

The Gap Analysis Observations Review Meeting Minutes are meeting minutes captured in 306 “Conduct Gap Analysis with Lead Technologist or designated Subject Matter Expert”. Recommended Approach Review Meeting Minutes are meeting minutes captured in 309 “Review and Approve Recommendation/Strategy of Recommended Approach (with SME)”. Proposed Testing Practices Improvement Plan Review Meeting Minutes are meeting minutes captured in 311 “Implement Recommendations/Strategy (with Enterprise Managers)”. Presentation of Assessment Improvement Plan to Client Meeting Minutes are meeting minutes captured in 312 “Implement Recommendations/Strategy (with client)”.

With reference now to FIG. 4, an example of a Graphical Testing Assessment Report is depicted in accordance with one embodiment of the present invention. Graphical report 400 is an example of a report that can be generated by a Testing Assessment Dashboard Spreadsheet 336 based on answers supplied by a consultant to questions in the Testing Assessment Questionnaire using formulas specific to the industry regarding best testing practices and can be presented to a client. Graphical report 400 contains a list of the five main areas of assessment: Testing Organization 402, Testing Strategy 404, Test Planning 406, Testing Management 408, and Testing Environment and Tools 410. Each main area of assessment 402-410 contains sublevels as indicated. Each sublevel has an associated level 418 score, such as, A, B, or C indicating how successful the analyzed organization's testing practices are in that area.

A bar chart is also provided for each sublevel as depicted in FIG. 4. The dotted bar graphs such as bars 430-438 indicate the maximal potential score that can be achieved for the particular sublevel. The actual score for a sublevel is indicated by the cross-hatched bars such as, for example, bars 420-428. Areas having such sub-par assessment scores as to make them likely sources of severe problems have a darkened bar such as bars 412-416 corresponding, in this example, to sublevels Evaluation and Low-level Testing for main area Testing Strategy 404 and Test Specification Techniques in main are Test Planning 406. This indicates that these areas need specific attention.

In some preferred embodiments, bar graphs are illustrated in color to help aid the viewer in ascertaining the information presented. For example, in one embodiment, bars 412-416 might be illustrated in red to indicate that these are problem areas. Bars 420-428 may be illustrated in dark blue to indicate that actual rating for the particular area and bars 430-438 might be illustrated in light blue to illustrate the maximum possible rating for a particular area.

Graphical report 400 is provided merely as an example of a graphical report that can be produced by the Toolkit of the present invention and is not intended to imply any limitations as regards the format of the graphical report.

The toolkit supports consistent application of the testing assessment process and provides a visual “dashboard” (e.g., graphical report 400) view of the client's testing maturity. The toolkit includes a number of supporting documents and spreadsheets that lead to objective, measurable assessment findings and recommendations. Furthermore, the creation of the toolkit supports the ability to assess the state of testing using the industry concept of a maturity continuum, so that a consultant can clearly communicate to clients on the client's level of maturity and how to get to the next levels of maturity.

In other embodiments, the areas of focus (testing organization, testing strategy, test planning, testing management, and testing environment and tools) could be changed. The assessment would therefore provide information on improving testing, but with different focal areas. If the number of focus areas is drastically increased, it would affect the amount of time required to complete interviews across all focus areas, and essentially broaden the scope of the engagement. This in turn would affect the speed at which the assessment could be completed and would increase the cost to the end client. The assessment could also use the same questions but alter their order. The organization and/or appearance of the dashboard (e.g., graphical report 400) view could also be altered.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

### Appendix A

Testing Assessment Questionnaire Worksheet

| | | | Suggested |
|---|---|---|---|
| Key Area/Level/Checkpoint | Y/N | Notes | Improvements |
| At an organization level, there is monitoring of the | | | Make (someone in) the |
| application of the methodology (methods, standards, | | | testing line department |
| techniques and procedures) of the organization. | | | responsible for monitoring |
| | | | the application of the |
| | | | methodology. |
| Deviations are sufficiently argued, documented and | | | Provide checklists, etc., on |
| reported to the testing process owner. | | | the basis of which the |
| | | | evaluation takes place. |
| In the case of deviations, the risks are analyzed and | | | This activity should take |
| adjustments are made, for example by adapting the | | | place during project |
| methodology or by adapting activities or products so | | | closedown on every |
| that they still meet the methodology. The adjustment is | | | project. The results should |
| substantiated. | | | provide the basis for |
| | | | evaluating the need to |
| | | | modify the generic testing |
| | | | methodology. |
| Estimating and Planning | | Test planning and estimating | |
| | | indicate which activities have | |
| | | to be executed when and how | |
| | | many resources (people) are | |
| | | needed. High-quality | |
| | | estimating and planning are | |
| | | very important, because these | |
| | | are the basis for allocating | |
| | | capacity. Unreliable planning | |
| | | and estimating frequently | |
| | | result either in delays because | |
| | | not enough resources are | |
| | | allocated to perform the | |
| | | activities in a certain time | |
| | | frame, or in less efficient use | |
| | | of resources because too | |
| | | many resources are allocated. | |
| Substantiated estimating and planning | | A first important step in getting | Try to validate estimating |
| | | control of the planning and | in a number of ways. |
| | | estimating of the test effort is | Possible ways to estimate |
| | | that the results of these | the effort are as follows: |
| | | activities can be | Take a percentage of the |
| | | substantiated. In this way, the | total effort, based on |
| | | planning and estimating are | experiences with similar |
| | | usually of a higher quality, | test processes (for |
| | | being more reliable and more | example, functional |
| | | efficient in the allocation of | design: 20%, technical |
| | | resources. When there is a | design, realization, and |
| | | deviation, a better analysis | unit test: 40-45%, system |
| | | can be made regarding | test: 15-20%, acceptance |
| | | whether this is an isolated | test 20%). |
| | | incident or whether it is | Employ standard ratios in |
| | | systemic. In the second case, | testing, based on |
| | | the entire planning probably | experiences with similar |
| | | has to be revised and possibly | test processes (some |
| | | even the method of | ratios are: 10% |
| | | estimating. A structured | preparation, 40% |
| | | working method enables | specification, 45% |
| | | improvement. | execution including one |
| | | Optimal planning and | retest, 5% completion; |
| | | estimating are very important | execution of a retest takes |
| | | Incorrect planning or budgets | only 50% of the execution |
| | | can be costly: all the stops | of a first test, because the |
| | | have to be pulled out to still | testware is now tested and |
| | | meet the planning or | reusable). Budget the |
| | | estimating requirements, | overhead at 10-20%. |
| | | testing activities overrun their | Estimate the hours of the |
| | | time, or testing activities will | separate activities and |
| | | be cancelled (causing more | subsequently extrapolate |
| | | insecurity about the quality of | these. For example, |
| | | the object to be tested). | specifying test cases for |
| | | | one function takes four |
| | | | hours; there are 100 |
| | | | functions, so 400 hours are |
| | | | needed. Adding an |
| | | | estimate of 50 hours for |
| | | | other activities in the |
| | | | specification phase |
| | | | (infrastructure!) produces a |
| | | | total of 450 hours. Now, |
| | | | further extrapolation is |
| | | | possible by means of the |
| | | | standard ratios (see item |
| | | | above). |
| | | | Extrapolate the results of |
| | | | a test pilot. |
| | | | Reduce to percentages |
| | | | per test level (program, |
| | | | integration, system, and |
| | | | acceptance tests). |
| | | | Use Test Point Analysis |
| | | | (TPA). Using this |
| | | | technique, test hours are |
| | | | estimated based on |
| | | | function points, quality |
| | | | attributes to test, and |
| | | | required test depth. |
| | | | Various influencing |
| | | | attributes are taken into |
| | | | account. For a detailed |
| | | | description: see Tmap. |
| The test estimating and planning can be substantiated | | | Gain insight into (the |
| (so not just “we did it this way in the last project”). | | | quality of) the method of |
| | | | estimating and planning |
| | | | (for example, by analyzing |
| | | | the estimating and |
| | | | planning of previous |
| | | | projects, and how |
| | | | reliable these were). |
| | | | Work out a procedure |
| | | | for setting up a test |
| | | | estimation (for example, |
| | | | a minimum of two rules |
| | | | of thumb applied). |
| | | | Agree beforehand how to |
| | | | deal with learning time, |
| | | | excess work, and waiting times. |
| | | | In the planning take into |
| | | | account the required time for: |
| | | | transfer (from the previous |
| | | | phase) and installation |
| | | | of the test object; |
| | | | rework and retests. |
| | | | In practice, a good working |
| | | | method for planning turns |
| | | | out to be to plan the entire |
| | | | test process globally and |
| | | | each time make a detailed |
| | | | plan for the next three to |
| | | | four weeks. |
| In the testing process, estimating and planning are | | | After finishing the project, |
| monitored, and adjustments are made if needed. | | | verify the estimating and |
| | | | the procedure and if |
| | | | necessary adjust the |
| | | | procedure. |
| Statistically substantiated estimating and planning | | Metrics can be analyzed. | |
| | | Based on this analysis, the | |
| | | working method of planning | |
| | | and estimating can be | |
| | | optimized further. | |
| Metrics about progress and quality are structurally | | | Arrange that each project |
| maintained (on level B of the key area Metrics) for | | | indicates in general terms |
| multiple, comparable projects. | | | its progress and quality |
| | | | (defects) in reporting. Later |
| | | | more detail is applied, |
| | | | guided from the line |
| | | | organization. A point of |
| | | | interest is the growth in |
| | | | functionality compared to |
| | | | the initial planning: often |
| | | | the functionality of a |
| | | | system increases, notably |
| | | | during the building and test |
| | | | phases. This is often |
| | | | visible in the form of a |
| | | | continuous flow of change |
| | | | requests. |
| This data is used to substantiate test estimating and | | | Let the line department for |
| planning. | | | testing manage and |
| | | | periodically analyze these |
| | | | metrics, looking for |
| | | | costs/profit index numbers. |
| | | | Which systems gave many |
| | | | problems in production, |
| | | | which systems fewer? |
| | | | What is the relationship |
| | | | between the index |
| | | | numbers and the tests |
| | | | performed, the |
| | | | development method |
| | | | applied, and so on? |
| | | | Ensure that on the basis of |
| | | | the above-mentioned |
| | | | information, improvement |
| | | | measures are proposed |
| | | | and implemented. |
| Metrics | | Metrics are quantified | |
| | | observations of the | |
| | | characteristics of a product or | |
| | | process, for example the | |
| | | number of lines of code. For | |
| | | the test process, metrics of | |
| | | the progress of the process | |
| | | and the quality of the tested | |
| | | system are very important. | |
| | | They are used to manage the | |
| | | testing process, to | |
| | | substantiate the testing advice | |
| | | and also to make it possible to | |
| | | compare systems or | |
| | | processes. Why does one | |
| | | system have far fewer failures | |
| | | in production than another, or | |
| | | why is one testing process | |
| | | faster and more thorough than | |
| | | another? Metrics are | |
| | | specifically important for | |
| | | improving the testing process | |
| | | to assess the consequences | |
| | | of certain improvement | |
| | | measures, by comparing data | |
| | | before and after the | |
| | | implementation of the | |
| | | measure. | |
| | | Input: information about the | |
| | | resources used (people, | |
| | | computers, tools, other | |
| | | products, . . . ) and the process | |
| | | steps or activities performed; | |
| | | Output: information about the | |
| | | products to be delivered; | |
| | | Result: information about the | |
| | | use and effectiveness of the | |
| | | delivered products compared | |
| | | to the set requirements. | |
| Project metrics (product) | | For the testing process, | Begin on a small scale: |
| | | metrics concerning the | record the hours and lead |
| | | progress of the process and | time for the phases and |
| | | the quality of the tested | the number of defects per |
| | | system are of great | phase. Start measuring as |
| | | importance. They are used for | early as possible, |
| | | managing the testing process, | preferably even before the |
| | | to substantiate the testing | start of the improvement |
| | | advice, and also to compare | process, so that later there |
| | | systems or processes. This | will be comparison |
| | | level consists of metrics for | material. |
| | | Input and Output. | Arrange that the |
| | | | organization (and not each |
| | | | project separately) is |
| | | | involved in determining the |
| | | | metrics to be recorded. |
| | | | The implementation of |
| | | | metrics is often regarded |
| | | | as a separate project |
| | | | because of the impact it |
| | | | has on the organization. |
| | | | Bear this in mind and do |
| | | | not underestimate the |
| | | | potential problems. There |
| | | | is much literature available |
| | | | on this subject. |
| | | | Never use metrics to check |
| | | | people on an individual |
| | | | basis, for example their |
| | | | productivity. The danger of |
| | | | incorrect interpretation is |
| | | | too great. Also, it could |
| | | | lead to manipulation of |
| | | | data. |
| | | | Make the metrics a |
| | | | permanent part of the |
| | | | templates for (end) |
| | | | reporting and for test plans |
| | | | (for substantiating test |
| | | | estimating). |
| In the (test) project Input metrics are recorded: | | | |
| used resources - hours, | | | |
| performed activities - hours and lead time | | | |
| size and complexity of the tested system - in function | | | |
| points, number of functions and/or building effort | | | |
| During testing, output metrics are recorded: | | | |
| testing products - specifications and test cases, log reports, | | | |
| testing progress - performed tests, status (finished/not finished), | | | |
| number of defects - defects by test level, by subsystem, | | | In good defect |
| by cause, priority, status (new, in solution, corrected, | | | administration, this |
| re-tested). | | | measuring can be |
| | | | expanded continuously. |
| The metrics are used in test reporting. | | | |
| Project metrics (process) | | Besides the Input and Output | Tools often provide good |
| | | metrics of the preceding level, | support in collecting |
| | | in this level the Result metrics | metrics. |
| | | are also looked at: how well | |
| | | do we test anyway? Just | |
| | | going by the number of | |
| | | defects found does not tell us | |
| | | much about this: if many | |
| | | defects are found, it does not | |
| | | always mean that the test was | |
| | | good; development might | |
| | | have been badly done. On the | |
| | | other hand, few defects found | |
| | | might mean that the system | |
| | | has been built well, but might | |
| | | also mean that the testing has | |
| | | been insufficient. | |
| | | Metric information is useful for | |
| | | substantiating advice about | |
| | | the quality of the tested object | |
| | | and can also serve as input | |
| | | into the improvement of the | |
| | | testing process. When the | |
| | | testing process has been | |
| | | improved, metrics help to | |
| | | visualize the results of | |
| | | improvements. | |
| During testing, Result measurements are made for at | | | |
| least 2 of the items mentioned below: | | | |
| defect find-effectiveness: | | | Begin as soon as possible |
| the found defects compared to the total defects | | | with the registering of |
| present (in %); the last entity is difficult to measure, but | | | defect find-effectiveness |
| think of the found number of defects in later tests or in | | | (number of defects in |
| the first months of production; | | | test/number of defects in |
| analyze which previous test should have found the | | | production) and defect |
| defects (this indicates something about the | | | find-efficiency (number of |
| effectiveness of preceding tests!); | | | defects in test/number of |
| | | | test hours). |
| defect find-efficiency: | | | |
| the number of found defects per hour spent, | | | |
| measured over the entire testing period or over several | | | |
| testing periods; | | | |
| test coverage level: | | | |
| the test targets covered by a test case compared to | | | |
| the number of possible test targets (in %). These | | | |
| targets can be determined for functional specifications | | | |
| as well as for the software, think for example of | | | |
| statement or condition coverage; | | | |
| testware defects: | | | |
| the number of “defects” found whose cause turned out | | | |
| to be wrong testing, compared to the total number of | | | |
| defects found(in %); | | | |
| perception of quality: | | | |
| by means of reviews and interviews of users, testers | | | |
| and other people involved. | | | |
| Metrics are used in the test reporting. | | | |
| System metrics | | The functioning of a system in | Compare defect-find- |
| | | production is in fact the final | effectiveness and defect- |
| | | test. Expanding metrics to | find-efficiency for multiple, |
| | | cover the entire system | comparable projects. |
| | | instead of just the | Arrange that the line |
| | | development phase gives a | department for testing |
| | | much higher quality of | manages testing metrics |
| | | information acquired. The | centrally. Each project |
| | | metric information from the | transfers its accumulated |
| | | development phase can in | metrics to this line |
| | | fact give a very positive image | department. |
| | | of the system quality, but | |
| | | when subsequently a massive | |
| | | amount of failures occur in | |
| | | production, this should be | |
| | | taken into account in making a | |
| | | judgment. | |
| Metrics mentioned above are recorded for development | | | |
| Metrics mentioned above are recorded for maintenance. | | | |
| Metrics mentioned above are recorded for production. | | | |
| Metrics are used in the assessment of the effectiveness | | | The testing line |
| and efficiency of the testing process. | | | department assesses the |
| | | | effectiveness and |
| | | | efficiency of testing |
| | | | processes. |
| Organization metrics (>1 system) | | The quality of one system is | |
| | | higher than the quality of | |
| | | another. By making use of | |
| | | mutually comparable metrics, | |
| | | better systems can be | |
| | | recognized and the | |
| | | differences analyzed. These | |
| | | results can be used for further | |
| | | process improvement | |
| Organization-wide mutually comparable metrics are | | | The testing line |
| maintained for the already mentioned data. | | | department demands |
| | | | uniform metrics from the |
| | | | different projects. |
| Metrics are used in assessing the effectiveness and | | | Each project and the |
| efficiency of the separate testing processes, to achieve | | | maintenance organization |
| an optimization of the generic test methodology and | | | transfers the accumulated |
| future testing processes. | | | metrics to the testing line |
| | | | department. |
| Reporting | | Testing is not so much about | |
| | | ‘finding defects’ as providing | |
| | | insight into the quality level of | |
| | | the product. Therefore | |
| | | reporting is considered the | |
| | | most important product of the | |
| | | testing process. Reporting | |
| | | should be focused on giving | |
| | | substantiated advice to the | |
| | | customer concerning the | |
| | | product and even the system | |
| | | development process. | |
| Defects | | The first level simply confirms | |
| | | that reporting is being done. | |
| | | Reporting the total number of | |
| | | defects found and those still | |
| | | unsolved is a minimum | |
| | | requirement. This provides a | |
| | | first impression of the quality | |
| | | of the system to be tested. | |
| | | Furthermore, it is important | |
| | | that reporting should take | |
| | | place periodically, because | |
| | | merely reporting at the end | |
| | | gives the project no room for | |
| | | adjustments. | |
| The defects found are reported periodically, divided into | | There is a defect tracking | Find out approximately |
| solved and unsolved defects. | | system | how many defects have |
| | | § Know how many defects are | been found, regardless of |
| | | found (open, closed, verified) | whether they have been |
| | | Should not cost too much time | solved or not. |
| | | to draw up the reporting | List the unsolved defects. |
| | | | These are defects that are |
| | | | yet to be solved as well as |
| | | | those that will not be |
| | | | solved, even if the defect is |
| | | | justified (these are the |
| | | | known errors). |
| | | | Arrange for the handling of |
| | | | the defects to be done |
| | | | according to a tight |
| | | | administrative procedure. |
| | | | The condition for this |
| | | | procedure is that it should |
| | | | not cost too much time to |
| | | | draw up the reporting |
| | | | described above. |
| Progress (status of tests and products), activities (cost | | The test reporting contains | |
| and time, milestones), defects with priorities | | extra information in the form | |
| | | of the planned, spent so far, | |
| | | and still required budgets and | |
| | | lead time. This information is | |
| | | relevant because the | |
| | | customer gains faster insight | |
| | | into the costs of testing and | |
| | | the feasibility of the (total) | |
| | | planning. In addition, the | |
| | | reported defects are probably | |
| | | less serious than one | |
| | | production-blocking defect, | |
| | | increasing insight into the | |
| | | relative quality of the tested | |
| | | system. | |
| The defects are reported, divided into seriousness | | | Make the project aware |
| categories according to clear and objective norms. | | | that the mere fact that |
| | | | there are no remaining |
| | | | unsolved defects does not |
| | | | mean that one can |
| | | | conclude that the test |
| | | | gives positive advice. It |
| | | | could be the case, for |
| | | | example, that a defect |
| | | | found in function A has a |
| | | | structural character and is |
| | | | also present in functions B |
| | | | to Z. When the defect is |
| | | | solved for function A, this |
| | | | does not say anything |
| | | | about the possibility that |
| | | | the defect is still present in |
| | | | functions B to Z. The |
| | | | advice could then be to |
| | | | test these functions again, |
| | | | before releasing the test |
| | | | object. |
| The progress of each test activity is reported | | | Focus on the most |
| periodically and in writing. Aspects reported on are: | | | important defects. |
| lead time, hours spent which tests have been | | | |
| specified, what has been tested, what part of the object | | | |
| performed correctly and incorrectly and what must still | | | |
| be tested. | | | |
| The following items are captured on the test results | | | By doing progress |
| logs: | | | reporting, what testing |
| Level/phase/type of testing being performed | | | does and approximately |
| Object under test and the system (sub-system) to | | | how much time each |
| which it relates | | | activity costs become |
| Version number of the object | | | visible. This increases |
| Unique number or identifier for the test case | | | insight and (mutual) |
| Date the test case was executed | | | understanding. |
| Name of the person who executed the test case | | | |
| Test or re-test | | | |
| Name of the person who performed a re-test | | | |
| Date the test case was re-tested | | | |
| Actual results obtained for each test case | | | |
| ‘Pass’ or ‘Failure’ status of the test | | | |
| Risks and recommendations, substantiated with metrics | | Substantiated as much as | |
| | | possible with trend analysis of | |
| | | metrics (budgets, time, and | |
| | | quality (defects)), risks are | |
| | | indicated with regard to (parts | |
| | | of) the tested object. Risks | |
| | | can be, for example, not | |
| | | meeting the date on which the | |
| | | object has to be taken into | |
| | | production or the tested object | |
| | | being of insufficient quality. | |
| | | For the risks | |
| | | recommendations are made | |
| | | which focus mainly on the | |
| | | activities of testing. Such | |
| | | advice can be, for example, to | |
| | | execute a full retest for | |
| | | subsystem A and a limited | |
| | | retest for subsystem B. The | |
| | | main advantage is that such | |
| | | reporting makes it possible for | |
| | | the customer to take | |
| | | measures in time. | |
| | | Substantiating the advice with | |
| | | trend analyses provides the | |
| | | customer with the arguments | |
| | | for taking the (often costly) | |
| | | measures. | |
| A quality judgment on the test object is made. The | | | Take the chosen testing |
| judgment is based on the acceptance criteria, if | | | strategy as a starting point. |
| present, and related to the testing strategy. | | | Did we deviate from it? |
| | | | Was this strategy already |
| | | | ‘thin’? Did retesting still |
| | | | proceed in a structured |
| | | | manner? How large is the |
| | | | change of regression? Ask |
| | | | these questions for each |
| | | | quality characteristic to be |
| | | | tested. Try to estimate the |
| | | | risks on the basis of the |
| | | | answers, and propose |
| | | | measures. |
| Possible trends with respect to progress and quality are | | | |
| reported periodically and in writing. | | | |
| The reporting contains risks (for the customer) and | | | |
| recommendations. | | | |
| The quality judgment and the detected trends are | | | Substantiate the most |
| substantiated with metrics (from the defect | | | important conclusions with |
| administration and the progress monitoring). | | | facts if possible: metrics |
| | | | from progress monitoring |
| | | | and defect administration, |
| Recommendations focus on Software Process | | In this form of reporting the | |
| Improvement | | recommendations deal not | |
| | | merely with test activities, but | |
| | | also with activities outside | |
| | | testing, that is, the entire | |
| | | system development process. | |
| | | For example, | |
| | | recommendations to perform | |
| | | (extra) reviews of the | |
| | | functional specifications, to | |
| | | organize version | |
| | | management, or to take into | |
| | | account in the project | |
| | | planning the required time for | |
| | | transferring software. In this | |
| | | form of reporting, testing | |
| | | focuses somewhat more on | |
| | | improving the process rather | |
| | | than the product and more on | |
| | | the prevention of defects (or in | |
| | | any case detecting them as | |
| | | soon as possible). | |
| Advice is given not only in the area of testing but also | | | Start small, with |
| on other aspects of the project. | | | recommendations that are |
| | | | valid only for the project. |
| | | | Involve the line |
| | | | departments in a later |
| | | | phase, because Software |
| | | | Process Improvement |
| | | | goes beyond projects (and |
| | | | the maintenance |
| | | | organization, etc.). |
| | | | Ensure that the line |
| | | | departments coordinate |
| | | | and monitor the |
| | | | recommendations. |
| Defect Management | | Although managing defects is | |
| | | in fact a project matter and not | |
| | | just the responsibility of the | |
| | | testers, the testers have the | |
| | | primary involvement. Good | |
| | | management should be able | |
| | | to track the life-cycle of a | |
| | | defect and also to support the | |
| | | analysis of quality trends in | |
| | | the detected defects. Such | |
| | | analysis is used, for example, | |
| | | to give well-founded quality | |
| | | advice. | |
| Internal defect management | | Recording defects in a defect | |
| | | management system helps to | |
| | | provide good administrative | |
| | | handling and monitoring, and | |
| | | is also a source of information | |
| | | about the quality of the | |
| | | system. Handling and | |
| | | monitoring ensures that | |
| | | defects do not remain | |
| | | unsolved without a decision | |
| | | having been made by the right | |
| | | person. As a result for | |
| | | example, a developer can | |
| | | never dismiss a defect as | |
| | | unjust without another person | |
| | | having looked at it. | |
| | | To get an impression of the | |
| | | quality of a system, it is | |
| | | interesting to know not only | |
| | | that there are no outstanding | |
| | | open defects, but also the | |
| | | total number of defects, as | |
| | | well as their type, severity and | |
| | | priority. | |
| The different stages of the defect-management life | | | Define and administer |
| cycle are administered (up to and including retest). | | | defect management |
| | | | process and procedure |
| | | | (workflow). |
| | | | Maintaining this workflow |
| | | | can be done with a |
| | | | spreadsheet or word |
| | | | processor, unless: |
| | | | a very large number of |
| | | | defects are expected (for |
| | | | example, in a large project, |
| | | | and/or |
| | | | comprehensive reporting |
| | | | is required (see also the |
| | | | next level). |
| | | | For those cases it is better |
| | | | to use a tool specifically |
| | | | designed for defect |
| | | | management. |
| The following characteristics of each defect are | | | Assign responsibility for |
| recorded: | | | defect management. The |
| unique number | | | aim of this task is to |
| person entering the defect | | | channel the defects and |
| date | | | their solutions adequately. |
| seriousness category | | | This individual functions as |
| problem description | | | a middleman for defects on |
| status indication | | | the one hand and solutions |
| | | | on the other. He/she leads |
| | | | a Defect Review group. |
| | | | made up representative |
| | | | testers, developers, and |
| | | | users. The advantages are |
| | | | that the quality of the |
| | | | defects and solutions is |
| | | | more carefully checked |
| | | | and communication is |
| | | | streamlined. |
| Extensive defect management with flexible reporting | | Data relevant to good | |
| facilities | | handling is recorded for the | |
| | | various defects. This clarifies, | |
| | | for resolution as well as for | |
| | | retesting, which part of the | |
| | | test basis or the test object | |
| | | the defect relates to and | |
| | | which test cases detected the | |
| | | defect By using | |
| | | comprehensive reporting, | |
| | | aggregated information can | |
| | | be gathered, which helps in | |
| | | spotting trends as soon as | |
| | | possible. Trends are, for | |
| | | example, an observation that | |
| | | most of the defects relate to (a | |
| | | part of) the functional | |
| | | specifications, or that the | |
| | | defects are mainly | |
| | | concentrated on the screen | |
| | | handling. This information can | |
| | | be used as the basis for timely | |
| | | corrective action. | |
| Defect data needed for later trend analysis is recorded | | | Such defect administration |
| in detail: | | | usually requires automated |
| test type | | | support (self-built or a |
| test case | | | commercial package). |
| subsystem | | | |
| priority | | | |
| program plus version | | | |
| test basis plus version | | | |
| cause (probable + definitive) | | | |
| all status transitions of the defect, including dates | | | |
| a description of the problem solution | | | |
| version of the test object in which the defect is solved | | | |
| person who solved the problem (usually developer) | | | |
| Defect management lends itself to extensive reporting | | | Prioritizing the defects is |
| possibilities, which means that reports can be selected | | | essential: to make |
| and sorted in different ways. | | | discussions easier, make |
| | | | procedures run faster, and |
| | | | gain more insight into the |
| | | | test results. A special point |
| | | | of interest is arranging for |
| | | | quick handling of defects |
| | | | that block test progress. |
| There is someone responsible for ensuring that defect | | | |
| management is carried out properly and consistently. | | | |
| Project defect management | | Using a standard defect | |
| | | management process for each | |
| | | project is a great advantage. | |
| | | All parties involved in system | |
| | | development - developers, | |
| | | users, testers, QA personnel, | |
| | | etc. - can enter defects as well | |
| | | as solutions for defects. This | |
| | | approach greatly simplifies | |
| | | communication concerning | |
| | | the handling of defects. Also, | |
| | | a central administration | |
| | | provides extra possibilities for | |
| | | retrieving information (e.g., for | |
| | | multiple, comparable | |
| | | projects). A point of interest is | |
| | | authorizations, which means | |
| | | that unwanted changing or | |
| | | closing of defects must be | |
| | | prevented. | |
| Defect management is used integrally in each project. | | | |
| The defects originate from the various disciplines, those | | | |
| who develop the solution add their solution to the | | | |
| administration themselves, etc . . . Note: For low-level | | | |
| tests, the developers may want to record defects that | | | |
| will affect other units and other developers. | | | |
| Authorizations ensure that each user of the defect | | | Defining authorizations |
| management system can only do what he or she is | | | well and having a good |
| allowed to do. | | | understanding of how to |
| | | | use the defect |
| | | | management system - are |
| | | | of importance here, |
| | | | because otherwise there is |
| | | | insufficient certainty that |
| | | | defects are being handled |
| | | | consistently. |
| Testware Management | | The products of testing should | |
| | | be maintainable and reusable | |
| | | and so they must be | |
| | | managed. Besides the | |
| | | products of the testing, such | |
| | | as test plans, specifications, | |
| | | databases and files, it is | |
| | | important that the products of | |
| | | previous processes such as | |
| | | requirements, functional | |
| | | design and code are managed | |
| | | well, because the test | |
| | | processing can be disrupted if | |
| | | the wrong program versions, | |
| | | etc. are delivered. If testers | |
| | | can rely on version | |
| | | management of these | |
| | | products, the testability of the | |
| | | product is increased. | |
| Internal testware management | | Good (version) management | |
| | | of the internal testware, such | |
| | | as test specifications, test files | |
| | | and test databases, is | |
| | | required for the fast execution | |
| | | of (re-)tests. Also, changes in | |
| | | the test basis will cause | |
| | | revision of test cases. To find | |
| | | out which test cases are | |
| | | involved, understanding the | |
| | | relationship between the test | |
| | | basis and test cases is very | |
| | | important. | |
| The testware (test cases, starting test databases, and | | | Make someone |
| other collateral created by the test team), test basis, | | | responsible for testware |
| test object, test documentation and test guidelines are | | | management. |
| managed internally according to a described procedure, | | | Define the testware |
| containing steps for delivery, registration, archiving and | | | management procedure |
| reference. | | | and communicate this |
| | | | procedure. An example of |
| | | | the basic steps is given |
| | | | below: |
| | | | Delivery: the products to |
| | | | be managed are delivered |
| | | | by the testers to the |
| | | | testware manager. The |
| | | | products must be delivered |
| | | | complete (with date and |
| | | | version stamp). The |
| | | | manager does a |
| | | | completeness check. |
| | | | Products in an electronic |
| | | | form should follow a |
| | | | standard naming |
| | | | convention, which also |
| | | | specifies the version |
| | | | number. |
| | | | Registration: the |
| | | | testware manager |
| | | | registers the delivered |
| | | | products in his or her |
| | | | administration with |
| | | | reference to, among other |
| | | | things, the supplier's |
| | | | name, product name, date, |
| | | | and version number. In |
| | | | registering changed |
| | | | products, the manager |
| | | | should check that |
| | | | consistency between the |
| | | | different products is |
| | | | sustained. |
| | | | Archiving: a distinction |
| | | | is made between new and |
| | | | changed products. In |
| | | | general it can be said that |
| | | | new products are added to |
| | | | the archive and changed |
| | | | products replace the |
| | | | preceding version. |
| | | | Reference: issuing |
| | | | products to project team |
| | | | members or third parties |
| | | | takes place by means of a |
| | | | copy of the requested |
| | | | products (manual or |
| | | | automated). |
| The management comprises the relationships between | | | |
| the various parts (CM for test basis, test object, | | | |
| testware, etc.). This relationship is maintained | | | |
| internally by the testing team. | | | |
| Transfer to the testing team takes place according to a | | | Consider using version |
| standard procedure. The parts included in a transfer | | | management tools. |
| should be known: which parts and versions of the test | | | |
| object, which version of the test basis, solved defects, | | | |
| still unsolved defects, change requests. | | | |
| External management of test basis and test object | | Good management of the test | |
| | | basis and the test object is a | |
| | | project responsibility. When | |
| | | the management of the test | |
| | | basis and the test object is | |
| | | well organized, testing can | |
| | | make a simple statement | |
| | | about the quality of the | |
| | | system. A great risk in | |
| | | insufficient management is, | |
| | | for example, that the version | |
| | | of the software that eventually | |
| | | goes into production differs | |
| | | from the tested version. | |
| The test basis and the test object (usually design and | | | Try to collect a number of |
| software) are managed by the project according to a | | | examples of what went |
| described procedure, with steps for delivery, | | | wrong as a result of faulty |
| registering, archiving and reference (i.e., configuration | | | version management Use |
| management) | | | these to make |
| | | | management aware of the |
| | | | importance of version |
| | | | management, from a |
| | | | testing point of view as |
| | | | well as from a project point |
| | | | of view. |
| Project level configuration management contains the | | | When version |
| relationships between the various parts of the system | | | management is |
| (e.g., test basis and test object). | | | insufficiently rigorous, |
| | | | indicate the associated |
| | | | risks in the test advice: |
| | | | ‘The system we have |
| | | | tested is of good quality, |
| | | | but we have no certainty |
| | | | that this will be the |
| | | | production version or that |
| | | | this is the version that the |
| | | | customer expects to get.’ |
| | | | Also indicate how much |
| | | | the testing process has |
| | | | suffered from insufficient |
| | | | version management, for |
| | | | example that much |
| | | | analysis has been |
| | | | necessary and/or many |
| | | | unnecessary defects have |
| | | | been found. |
| The testing team is informed about changes in test | | | Gain insight into the way in |
| basis or test object in a timely fashion. | | | which external |
| | | | management is/should be |
| | | | coordinated (‘narrow- |
| | | | mindedness’ is often the |
| | | | cause of bad version |
| | | | management; each |
| | | | department or group has |
| | | | its own version |
| | | | management or has the |
| | | | relevant components well |
| | | | organized, but coherence |
| | | | between the various |
| | | | components is |
| | | | insufficiently managed). |
| Reusable testware | | Making the testware reusable | |
| | | prevents the labor-intensive | |
| | | (re)specification of test cases | |
| | | in the next project phase or | |
| | | maintenance phase. Although | |
| | | this may sound completely | |
| | | logical, practice shows that in | |
| | | the stressed period | |
| | | immediately before the | |
| | | release-to-production date, | |
| | | keeping testware properly up | |
| | | to date is often not feasible, | |
| | | and after completion of the | |
| | | test it never happens. It is, | |
| | | however, almost impossible to | |
| | | reuse another person's | |
| | | incomplete, not yet actualized | |
| | | testware. Because the | |
| | | maintenance organization | |
| | | usually reuses only a limited | |
| | | part of the testware, it is | |
| | | important to transfer that part | |
| | | carefully. Making good | |
| | | agreements, such as | |
| | | arranging beforehand which | |
| | | testware has to be transferred | |
| | | fully and properly up to date, | |
| | | is an enormous help in | |
| | | preventing the need to | |
| | | respecify test cases | |
| Upon completion of testing, a selection, which is agreed | | | Manage testware centrally, |
| on beforehand, of the testing products are transferred | | | under CM. Establish and |
| to the maintenance organization, after which the | | | sustain good |
| transfer is formally accepted. | | | communication with the |
| | | | maintenance organization |
| | | | (or the next project). |
| | | | The problem in keeping |
| | | | testware up-to-date lies |
| | | | particularly in the fact that |
| | | | relatively small changes in |
| | | | the test basis can have |
| | | | large consequences for the |
| | | | testware. When the |
| | | | functional specification is |
| | | | revised in 10 minutes and |
| | | | the programmer |
| | | | implements the change in |
| | | | 2 hours, is it acceptable for |
| | | | the actual testing of a |
| | | | change to take 4 hours, |
| | | | plus the 20 hours needed |
| | | | to adapt the testware? A |
| | | | possible solution to this |
| | | | dilemma is reducing the |
| | | | amount of testware that |
| | | | needs to be complete and |
| | | | up-to-date at all times. This |
| | | | restriction is dependent, at |
| | | | least in part, on how many |
| | | | times the testware is to be |
| | | | (re-)used? |
| The transferred testing products are actually reused. | | | The maintenance |
| | | | organization must in fact |
| | | | perform the testing with the |
| | | | transferred testware. Is it |
| | | | possible to lend testers |
| | | | from the current test team |
| | | | to the maintenance |
| | | | organization for a short |
| | | | time, to simplify and |
| | | | secure the reuse of the |
| | | | testware? Also, the |
| | | | maintenance organization |
| | | | must have or acquire |
| | | | knowledge of the test |
| | | | techniques used. |
| Traceability of system requirements to test cases | | The products of the different | |
| | | phases of the development | |
| | | cycle are mutually related: the | |
| | | system requirements are | |
| | | translated into a functional | |
| | | design, which in turn is | |
| | | translated into a technical | |
| | | design, on the basis of which | |
| | | the programs are coded. Test | |
| | | cases are made from the test | |
| | | basis (the system | |
| | | requirements and/or the | |
| | | functional and/or technical | |
| | | design) and executed on the | |
| | | test object (software, user's | |
| | | manual, etc.). Good | |
| | | management of these | |
| | | relationships presents a | |
| | | number of advantages for | |
| | | testing: | |
| | | There is much insight into | |
| | | the quality and depth of the | |
| | | test because for all system | |
| | | requirements, the functional | |
| | | and technical design, and the | |
| | | software, it is known which | |
| | | test cases have been used to | |
| | | check them (or will be). This | |
| | | insight reduces the chance of | |
| | | omissions in the test. | |
| | | When there are changes in | |
| | | the test basis or test object, | |
| | | the test cases to be adapted | |
| | | and/or re-executed can be | |
| | | traced quickly. | |
| | | When, as a result of severe | |
| | | time pressure, it is not | |
| | | possible to execute all | |
| | | planned tests, test cases will | |
| | | have to be canceled. Because | |
| | | the relationship with | |
| | | requirements, specifications, | |
| | | and programs is known, it is | |
| | | possible to cancel those test | |
| | | cases whose related | |
| | | requirements or specifications | |
| | | cause the smallest risk for | |
| | | operation and it is clear for | |
| | | which requirements or | |
| | | specifications less | |
| | | substantiated statements | |
| | | about quality are made. | |
| Each system requirement and specification is related to | | | Do not involve only the |
| one or more test cases in a transparent way, and vice | | | specifications in the test |
| versa. | | | basis, but also include the |
| | | | system requirements, user |
| | | | requirements, and |
| | | | business requirements. |
| | | | Each project should |
| | | | ensure that such |
| | | | requirements are defined |
| | | | and developed according |
| | | | to a generic standard for |
| | | | the IT organization. |
| These relationships are traceable through separate | | | In testware management, |
| versions (e.g., system requirement A, version 1.0, is | | | provide good links |
| related to functional design B, version 1.3, is related to | | | between the test cases, |
| programs C and D, version 2.5 and 2.7, and is related | | | the test basis, and the test |
| to test cases X to Z, version 1.4). | | | object. Good version |
| | | | management is required. |
| Testing Environment | | Test execution takes place in | |
| | | a testing environment. This | |
| | | environment mainly comprises | |
| | | the following components: | |
| | | hardware; | |
| | | software; | |
| | | means of communication; | |
| | | facilities for building and | |
| | | using databases and files; | |
| | | procedures. | |
| | | The environment should be | |
| | | composed and set up in such | |
| | | a way that, by means of the | |
| | | test results, it can be optimally | |
| | | determined to what extent the | |
| | | test object meets the | |
| | | requirements. The | |
| | | environment has a large | |
| | | influence on the quality, lead | |
| | | time, and cost of the testing | |
| | | process. Important aspects of | |
| | | the environment are | |
| | | responsibilities, management, | |
| | | on-time and sufficient | |
| | | availability, | |
| | | representativeness, and | |
| | | flexibility. | |
| Managed and controlled testing environment | | Testing should take place in a | |
| | | controlled environment. Often | |
| | | the environment is therefore | |
| | | separated from the | |
| | | development or production | |
| | | environment. Controlled | |
| | | means among other things | |
| | | that the testing team owns the | |
| | | environment and that nothing | |
| | | can be changed without the | |
| | | permission of the testing | |
| | | team. This control reduces the | |
| | | chance of disturbance by | |
| | | other activities. Examples of | |
| | | disturbances are: software | |
| | | deliveries that are installed | |
| | | without the knowledge of the | |
| | | testing team or changes in the | |
| | | infrastructure that lead to the | |
| | | situation where the testing | |
| | | environment is no longer | |
| | | aligned with the development | |
| | | or the production | |
| | | environment. | |
| | | The more the testing | |
| | | environment resembles the | |
| | | final production environment, | |
| | | the more certainty there is | |
| | | that, after deployment to | |
| | | production, no problems will | |
| | | arise that are caused by a | |
| | | deviant environment. In the | |
| | | testing of time-behavior in | |
| | | particular, a representative | |
| | | environment is of high | |
| | | importance. | |
| | | The environment should be | |
| | | organized in such a way that | |
| | | test execution can take place | |
| | | as efficiently as possible. An | |
| | | example is the presence of | |
| | | sufficient test database, so | |
| | | that the testers can test | |
| | | without interfering with each | |
| | | other. | |
| Changes and/or deliveries take place in the testing | | | If there is not enough |
| environment only with the permission of the testing | | | awareness in the rest of |
| manager. | | | the project, collect |
| | | | examples in which the test |
| | | | environment was |
| | | | ‘uncontrolled’ and |
| | | | communicate the problems |
| | | | that were caused. |
| The environment is set up in time. | | | Take measures concerning |
| | | | restrictive factors that |
| | | | cannot be changed (for |
| | | | example, when the lead |
| | | | time of the transfer of a |
| | | | delivery is always at least |
| | | | one week, restrict the |
| | | | number of (re-)deliveries |
| | | | by performing extra test |
| | | | work in the other |
| | | | environments or preceding |
| | | | test levels). |
| | | | Ensure that technical |
| | | | knowledge is available to |
| | | | the testing team. |
| The testing environment is managed (with respect to | | | Make sure that the |
| setup, availability, maintenance, version management, | | | responsibility for the |
| error handling, authorizations, etc.). | | | environment rests with the |
| | | | testing manager. |
| | | | A well-known testing |
| | | | problem is that tests |
| | | | executed in the same |
| | | | environment disturb each |
| | | | other To circumvent this |
| | | | problem and also decrease |
| | | | the lead time, consider |
| | | | organizing multiple test |
| | | | environments or |
| | | | databases. Testers can |
| | | | then work simultaneously |
| | | | without having to consider |
| | | | each other's tests. A |
| | | | disadvantage is that the |
| | | | management of the test |
| | | | environments becomes |
| | | | more complex. Also, shifts |
| | | | can be set up to overcome |
| | | | this (for example, team 1 |
| | | | performs tests in the |
| | | | morning, team 2 performs |
| | | | tests in the afternoon). |
| The saving and restoring of certain test situations can | | | Arrange for aspects such |
| be arranged quickly and easily, (i.e. different copies of | | | as the backup and restore |
| the database are available for the execution of different | | | of test situations, required |
| test cases and scenarios) | | | tools (query languages!), |
| | | | the number of required test |
| | | | databases, and so on to be |
| | | | available in time. |
| The environment is sufficiently representative for the | | | Obtain insight into what is |
| test to be performed, which means that the closer the | | | representative (this is often |
| test-level is to production, the more the environment is | | | more difficult than it seems |
| “as-if-production”. | | | at first sight) in terms of |
| | | | database sizing, |
| | | | parametrizing, contents, |
| | | | and other variations. Take |
| | | | into account the fact that |
| | | | each test level needs |
| | | | another representative |
| | | | environment (a system |
| | | | test, for example, is |
| | | | ‘laboratory’, an acceptance |
| | | | test ‘as-if-production’). |
| | | | Set up the environment |
| | | | and indicate the risks and |
| | | | possible measures |
| | | | required in the event of |
| | | | deviations. |
| Testing in the most suitable environment | | The level of control over the | |
| | | different testing environments | |
| | | is sufficiently high, which | |
| | | makes it easier to deviate | |
| | | from a ‘specific’ environment | |
| | | per test level. This makes it | |
| | | possible either to test in | |
| | | another environment (for | |
| | | example, execution of a part | |
| | | of the acceptance test in the | |
| | | system testing environment) | |
| | | or to adapt the allocated | |
| | | environment quickly. The | |
| | | advantage of testing in | |
| | | another environment is either | |
| | | that this environment is better | |
| | | suited (for example, a shorter | |
| | | lead time or better facilities for | |
| | | viewing intermediate results) | |
| | | or that a certain test can be | |
| | | executed earlier. There is a | |
| | | conscious balancing between | |
| | | acquiring test results sooner | |
| | | and a decrease in | |
| | | representativeness. | |
| High level testing is performed in a dedicated | | | |
| environment. | | | |
| Each test is performed in the most suitable | | | Start test execution as |
| environment, either by execution in another | | | soon as possible; consider |
| environment or by quickly and easily adapting its own | | | on the one hand the |
| environment. | | | advantages of a separate, |
| | | | controlled and |
| | | | representative |
| | | | environment and on the |
| | | | other the advantages of |
| | | | early testing and/or |
| | | | efficient test execution. |
| The environment is ready in time for the test and there | | | |
| is no disturbance by other activities during the test. | | | |
| The risks associated with suitability of the testing | | | |
| environment are analyzed and adequate measures | | | |
| taken to mitigate the risks (e.g., decision to perform | | | |
| UAT in the system testing environment). | | | |
| Environment on call | | | |
| The environment that is most suited for a test is very | | | |
| flexible and can quickly be adapted to changing | | | |
| requirements | | | |
| Test Automation | | Automation within the test | |
| | | process can take place in | |
| | | many ways and has in general | |
| | | one or more of the following | |
| | | aims: | |
| | | fewer hours needed, shorter | |
| | | lead time, | |
| | | more test depth, | |
| | | increased test flexibility, | |
| | | more and/or faster insight in | |
| | | test process status, | |
| | | better motivation of the | |
| | | testers. | |
| Use of tools | | This level includes the use of | |
| | | automated tools. The tools | |
| | | provide a recognizable | |
| | | advantage. | |
| A decision has been taken to automate certain activities | | | |
| in the planning and/or execution phases. The test | | | |
| management and the party who pays for the investment | | | |
| in the tools (generally, the line management or project | | | |
| management) are involved in this decision; | | | |
| Use is made of automated tools that support certain | | | It is preferable to make use |
| activities in the planning and execution phases (such as | | | of existing tools in the |
| a scheduling tool, a defects registration tool and/or | | | organization; see if these |
| home-built stubs and drivers); | | | meet the needs. |
| The test management and the party paying for the | | | |
| investment in the tools acknowledge that the tools | | | |
| being used provide more advantages than | | | |
| disadvantages. | | | |
| Managed test automation | | It is recognized at this level | |
| | | that the implementation, use | |
| | | and control of the test tools | |
| | | must be carefully guided, to | |
| | | avoid the risk of not earning | |
| | | back the investments in the | |
| | | test tool. It has also been | |
| | | determined whether the | |
| | | automated test execution is | |
| | | feasible and offers the desired | |
| | | advantages. When the | |
| | | answer is positive, this test | |
| | | automation has already been | |
| | | (partly) achieved. | |
| A well-considered decision has been taken regarding | | | |
| the parts of the test execution that should or should not | | | |
| be automated. This decision involves those types of | | | |
| test tools and test activities that belong to the test | | | |
| execution. | | | |
| If the decision on automation of the test execution is a | | | |
| positive one, there is a tool for test execution. | | | |
| The introduction of new test tools is preceded by an | | | Make an inventory and find |
| inventory of technical aspects (does the test tool work | | | a basis for the need for |
| in the infrastructure?) and any possible preconditions | | | and the necessity of tools. |
| set for the testing process (for example, test cases | | | Do not restrict the search |
| should be established in a certain structure instead of in | | | to commercially available |
| a free-text form, so that the test tool can use them as | | | packages. Even very |
| input); | | | small, personally created |
| | | | tools such as stubs, drivers |
| | | | and displays in the system |
| | | | can be very useful. |
| | | | Builders can often makes |
| | | | such tools within a short |
| | | | space of time. |
| If use is made of a Capture & Playback tool for | | | Arrange training and |
| automated test execution, explicit consideration is given | | | support for a tool that is to |
| during implementation to maintainability of the test | | | be purchased. |
| scripts included. | | | Ensure that expert |
| | | | knowledge about the tool |
| | | | is present within the team |
| | | | (this often concerns a |
| | | | person with a technical |
| | | | background, who may also |
| | | | have programming skills). |
| Most of the test tools can be reused for a subsequent | | | |
| test process. To do so, the management of the test | | | |
| tools has been arranged. The fact that ‘in general’ test | | | |
| tools should be reusable, means that the test tools that | | | |
| are used explicitly within one testing process need not | | | |
| be reusable; | | | |
| The use of the test tools matches the desired | | | |
| methodology of the testing process, which means that | | | |
| use of a test tool will not result in inefficiency or | | | |
| undesired limitations of the testing process. | | | |
| Optimal test automation | | There is an awareness that | |
| | | test automation for all test | |
| | | phases and activities can | |
| | | provide useful support. This | |
| | | is determined by investigating | |
| | | structurally where test | |
| | | automation could create | |
| | | further gains for the test | |
| | | process. The entire | |
| | | automated test process is | |
| | | evaluated periodically. | |
| A well-considered decision has been taken regarding | | | |
| the parts of the testing process that should or should | | | |
| not be automated. All possible types of test tool and all | | | |
| test activities are included in this decision. | | | |
| There is insight in the cost/profit ratio for all test tools in | | | |
| use (where costs and profits need not merely be | | | |
| expressed in terms of money). | | | |
| There is a periodic review of the advantages of the test | | | |
| automation. | | | |
| There is awareness of the developments in the test tool | | | Organize certain structural |
| market. | | | activities, such as keeping |
| | | | in touch with the |
| | | | developments on the test |
| | | | tool market, in a supporting |
| | | | line department for testing. |
| New test tools for the testing process are implemented | | | Describe and manage the |
| according to a structured process. Aspects that require | | | implementation process |
| attention within this process include: | | | and provide templates |
| aims (what should the automation yield in terms of | | | from the line department |
| time, money and/or quality) | | | for testing. |
| scope (which test levels and which activities should be | | | |
| automated) | | | |
| required personnel and expertise (any training to be | | | |
| taken); | | | |
| required technical infrastructure | | | |
| selecting the tool | | | |
| implementing the tool | | | |
| developing maintainable scripts | | | |
| setting up management and control of the tool. | | | |

1. A method for analyzing project testing practices of an organization, the method comprising:
providing a consultant with a set of documents utilized for initiating the testing practices assessment process;
providing the consultant with a testing assessment questionnaire, wherein the questions are tailored to a select number of key focal areas and provide the consultant with a standardized set of questions leading to repeatability of the process and quantization of results and recommendations;
providing the consultant with a spreadsheet for entering the consultant's observations and the organization's answers to the questionnaire; and
generating a graphical representation of maturity levels for a select number of sub-levels for at least one of the key focal areas.

2. The method as recited in claim 1, further comprising:
generating a testing assessment report based on the consultants observations, concerns, and recommendations.

3. The method as recited in claim 2, further comprising:
generating a high-level executive summary presentation that borrows key points from the testing assessment report which focus on business benefits associated with implementation of the recommendations contained within the testing assessment report.

4. The method as recited in claim 3, wherein the business benefits include at least one of improvements in efficiency that reduce time, improvements in efficiency that reduce cost, and improvements in effectiveness of testing practices the produce improved quality in the product of the project.

5. The method as recited in claim 1, wherein the graphical representation of maturity levels comprises presenting graphs indicating the maximum possible score for a sub-level and the actual score for the sub-level.

6. The method as recited in claim 5, wherein graphs for maximum possible scores are illustrated in a first color and graphs of actual scores are illustrated in a second color.

7. The method as recited in claim 6, wherein a graph of an actual score for a sub-level which has a score indicating that the sub-level needs particular attention are indicated by a third color.

8. A computer program product in a computer readable media for use in a data processing system for analyzing project testing practices of an organization, the computer program product comprising:
first instructions for providing a consultant with a set of documents utilized for initiating the testing practices assessment process;
second instructions for providing the consultant with a testing assessment questionnaire, wherein the questions are tailored to a select number of key focal areas and provide the consultant with a standardized set of questions leading to repeatability of the process and quantization of results and recommendations;
third instructions for providing the consultant with a spreadsheet for entering the consultant's observations and the organization's answers to the questionnaire; and
fourth instructions for generating a graphical representation of maturity levels for a select number of sub-levels for at least one of the key focal areas.

9. The computer program product as recited in claim 8, further comprising:
fifth instructions for generating a testing assessment report based on the consultants observations, concerns, and recommendations.

10. The computer program product as recited in claim 9, further comprising:
sixth instructions for generating a high-level executive summary presentation that borrows key points from the testing assessment report which focus on business benefits associated with implementation of the recommendations contained within the testing assessment report.

11. The computer program product as recited in claim 10, wherein the business benefits include at least one of improvements in efficiency that reduce time, improvements in efficiency that reduce cost, and improvements in effectiveness of testing practices the produce improved quality in the product of the project.

12. The computer program product as recited in claim 8, wherein the graphical representation of maturity levels comprises presenting graphs indicating the maximum possible score for a sub-level and the actual score for the sub-level.

13. The computer program product as recited in claim 12, wherein graphs for maximum possible scores are illustrated in a first color and graphs of actual scores are illustrated in a second color.

14. The computer program product as recited in claim 13, wherein a graph of an actual score for a sub-level which has a score indicating that the sub-level needs particular attention are indicated by a third color.

15. A system for analyzing project testing practices of an organization, the system comprising:
first means for providing a consultant with a set of documents utilized for initiating the testing practices assessment process;
second means for providing the consultant with a testing assessment questionnaire, wherein the questions are tailored to a select number of key focal areas and provide the consultant with a standardized set of questions leading to repeatability of the process and quantization of results and recommendations;
third means for providing the consultant with a spreadsheet for entering the consultant's observations and the organization's answers to the questionnaire; and
fourth means for generating a graphical representation of maturity levels for a select number of sub-levels for at least one of the key focal areas.

16. The system as recited in claim 15, further comprising:
fifth means for generating a testing assessment report based on the consultants observations, concerns, and recommendations.

17. The system as recited in claim 16, further comprising:
sixth means for generating a high-level executive summary presentation that borrows key points from the testing assessment report which focus on business benefits associated with implementation of the recommendations contained within the testing assessment report.

18. The system as recited in claim 17, wherein the business benefits include at least one of improvements in efficiency that reduce time, improvements in efficiency that reduce cost, and improvements in effectiveness of testing practices the produce improved quality in the product of the project.

19. The system as recited in claim 15, wherein the graphical representation of maturity levels comprises presenting graphs indicating the maximum possible score for a sub-level and the actual score for the sub-level.

20. The system as recited in claim 19, wherein graphs for maximum possible scores are illustrated in a first color and graphs of actual scores are illustrated in a second color.

21. The system as recited in claim 20, wherein a graph of an actual score for a sub-level which has a score indicating that the sub-level needs particular attention are indicated by a third color.
